(19) United States
(12) Patent Application Publication
(10) Pub. No.: US 2026/0045102 A1
(43) Pub. Date: Feb. 12, 2026

(54) 3D FEATURE PROVENANCE FOR TARGETING, EXPLOITATION, OR OTHER FUNCTIONS

(71) Applicant: Raytheon Company, Arlington, VA (US)

(72) Inventors: Stephen Raif, Nevada, TX (US); Jody D. Verret, Rockwall, TX (US); Kathryn A. Welin, Arlington, VA (US); Jennifer M. Swenson, Murphy, TX (US); Brett N. Appleton, Centreville, VA (US)

(21) Appl. No.: 19/173,406

(22) Filed: Apr. 8, 2025

Related U.S. Application Data
(60) Provisional application No. 63/682,126, filed on Aug. 12, 2024.

(51) Int. Cl. G06V 20/64; G06T 17/00

(52) U.S. Cl. CPC G06V 20/64; G06T 17/00

(57) ABSTRACT

A method includes obtaining three-dimensional (3D) features associated with a scene, where each 3D feature is extracted based on two or more of multiple images of the scene. The method also includes identifying provenance data associated with each of the 3D features, where the provenance data for each 3D feature identifies one or more sources of the two or more images used to extract the 3D feature. The method further includes storing the 3D features and the provenance data associated with the 3D features.

### CROSS-REFERENCE TO RELATED APPLICATION AND PRIORITY CLAIM

This application claims priority under 35 U.S.C. § 119(e) to U.S. Provisional Patent Application No. 63/682,126 filed on Aug. 12, 2024, which is hereby incorporated by reference in its entirety.

### TECHNICAL FIELD

This disclosure is generally directed to imaging systems. More specifically, this disclosure is directed to three-dimensional (3D) feature provenance for targeting, exploitation, or other functions.

### BACKGROUND

Various imaging systems can combine information from multiple images in order to generate three-dimensional (3D) models of scenes. For example, multiple images captured using one or more satellites can be used to construct a 3D point cloud or other 3D model of a scene.

### SUMMARY

This disclosure relates to three-dimensional (3D) feature provenance for targeting, exploitation, or other functions.

In a first embodiment, a method includes obtaining 3D features associated with a scene, where each 3D feature is extracted based on two or more of multiple images of the scene. The method also includes identifying provenance data associated with each of the 3D features, where the provenance data for each 3D feature identifies one or more sources of the two or more images used to extract the 3D feature. The method further includes storing the 3D features and the provenance data associated with the 3D features.

In a second embodiment, an apparatus includes at least one processing device configured to obtain 3D features associated with a scene, where each 3D feature is extracted based on two or more of multiple images of the scene. The at least one processing device is also configured to identify provenance data associated with each of the 3D features, where the provenance data for each 3D feature identifies one or more sources of the two or more images used to extract the 3D feature. The at least one processing device is further configured to store the 3D features and the provenance data associated with the 3D features.

In a third embodiment, a non-transitory machine readable medium contains instructions that when executed cause at least one processor to obtain 3D features associated with a scene, where each 3D feature is extracted based on two or more of multiple images of the scene. The non-transitory machine readable medium also contains instructions that when executed cause the at least one processor to identify provenance data associated with each of the 3D features, where the provenance data for each 3D feature identifies one or more sources of the two or more images used to extract the 3D feature. The non-transitory machine readable medium further contains instructions that when executed cause the at least one processor to store the 3D features and the provenance data associated with the 3D features.

Any single one or any combination of the following features may be used with the first, second, or third embodiment. The provenance data associated with each of the 3D features may include (i) a first identifier identifying a cluster of images used to extract the 3D feature and (ii) a second identifier identifying, within the cluster of images, which of the images were used to extract the 3D feature. The first identifier may be one byte in length, and the second identifier may be one byte in length. Each of the images may be associated with a timestamp, and at least one of the 3D features may be extracted using two or more images captured at different times. At least some of the 3D features and the provenance data may be processed to generate a visualization of the scene, and a graphical user interface including the visualization may be generated. A user selection of a point within the visualization may be received, and the graphical user interface may be updated to display an identification of the two or more images used to extract a 3D feature at the point within the visualization. Each 3D feature may be extracted by selecting a reference image from among the multiple images, selecting one or more complement images from among the multiple images, and extracting each 3D feature based on a presence of the 3D feature in the reference image and in at least one of the one or more complement images. A 3D model of the scene may be formed based on the 3D features.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting three-dimensional (3D) feature provenance for targeting, exploitation, or other functions according to this disclosure;

FIG. 2 illustrates an example device supporting 3D feature provenance for targeting, exploitation, or other functions according to this disclosure;

FIGS. 3 and 4 illustrate example processes for extracting 3D features and associated provenance data according to this disclosure;

FIGS. 5A and 5B illustrate an example format for provenance data according to this disclosure;

FIG. 6 illustrates an example graphical user interface containing content based on provenance data according to this disclosure; and

FIG. 7 illustrates an example method for identifying and using 3D feature provenance for targeting, exploitation, or other functions according to this disclosure.

### DETAILED DESCRIPTION

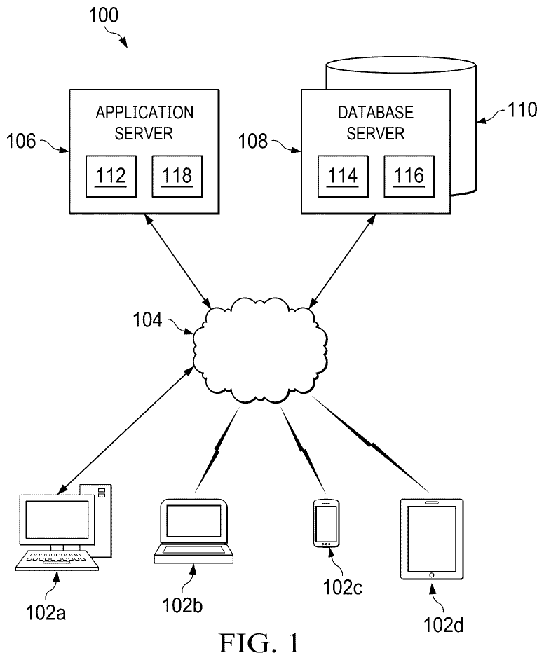

FIGS. 1 through 7, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, various imaging systems can combine information from multiple images in order to generate three-dimensional (3D) models of scenes. For example, multiple images captured using one or more satellites can be used to construct a 3D point cloud or other 3D model of a scene. As can be seen here, the accuracy of the 3D models can be very important. However, images used to generate a 3D model may be captured over a prolonged period of time, such as one or more years. Because of this, it is possible for objects within a scene to change over time, such as when an object moves or disappears. As a particular example, a building or other structure captured at one or more times may subsequently be demolished so that the structure no longer appears in later images. A 3D model generated using all of the images may still include the building or other structure, which can be problematic for various reasons. Prior approaches often focus on the exploitation and accuracy of rigorous error propagation, but information associated with the 3D models may be lost or may not be accessible to end users.

This disclosure provides various techniques for 3D feature provenance for targeting, exploitation, or other functions. As described in more detail below, 3D features associated with a scene can be extracted or otherwise obtained. The 3D features can represent or be used to generate a 3D model of the scene. The 3D model may have any suitable form, such as one or more 3D point clouds, digital surface models (DSMs), or polygonal meshes. The 3D features can be stored along with provenance data associated with the 3D features. For each 3D feature, the provenance data can be used to identify a source of that 3D feature, such as by identifying the satellite(s) or other device(s) used to capture images from which the 3D feature was extracted. Since each image can have an associated timestamp or other time-related information, the provenance data allows end users and analysis programs or other applications to identify times or timeframes associated with the 3D features, which allows the end users and applications to determine whether the 3D features are current or up-to-date in a 3D model. This disclosure also provides a format for storing the provenance data, such as by using two bytes of data (prior to compression) for each 3D feature. For example, one byte may identify a cluster of images, and another byte may identify the specific images within the cluster used to extract the associated 3D feature.

The 3D features and their associated provenance data here may be used for any suitable purposes. For instance, the 3D features may represent or be used to form 3D models of scenes that can be used in various ways. As particular examples, 3D models of scenes may be used for defense-related purposes, such as for targeting objects within the scenes. As a particular example, targeting of objects often involves the use of source-selection rules, which may specify that images can only be used when they have known geolocation errors within acceptable limits. Providing provenance for 3D features in 3D models can help to ensure that the geolocation errors of satellites or other devices can be verified as part of the targeting process. 3D models of scenes may be used for commercial or other civilian purposes, such as automated unmanned aerial vehicle (UAV) navigation. As a particular example, 3D models of scenes may be used to control the flightpaths of drones or other UAVs so that the UAVs avoid buildings or other structures within their operating environments.

In this way, it is possible to provide an end-to-end workflow for generating, storing, and exploiting provenance data. Because each 3D feature can have associated provenance data, it is possible for end users and applications to identify the provenance of the 3D features and make targeting, exploitation, navigation, or other decisions based on the provenance. Moreover, the provenance data can be stored in a compact format, which can be useful when large amounts of 3D features are associated with scenes. As a particular example, a 3D point cloud could include millions of points. Providing a compact format for storing provenance data of each 3D feature can be helpful for reducing storage and bandwidth requirements. Further, the described approaches allow the provenance data to be easily retrieved and analyzed to support other functions, such as functions that generate graphical user interfaces showing a 3D environment and provenance data of 3D features within the 3D environment. In addition, the described techniques can provide full traceability of all 3D features to their original source data (such as to the specific satellites or other devices that captured images) and when the source data was captured. This can help to ensure that 3D features are extracted from sources that meet various requirements or specifications, such as approved satellites or other devices.

FIG. 1 illustrates an example system 100 supporting 3D feature provenance for targeting, exploitation, or other functions according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and the network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100, such as via wired or wireless connections. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. In some cases, the application server 106 supports the execution of at least one application 112 that can obtain 3D features 114 and associate the 3D features 114 with provenance data 116. Each 3D feature 114 may represent or be associated with a three-dimensional geometric data object (such as a 3D point or 3D facet) representing an individual element of a 3D object or scene. For example, the application server 106 may process images from various satellites or other devices and extract the 3D features 114, and the application server 106 can generate the provenance data 116 based on the sources of the images used to extract each 3D feature 114. The 3D features 114 can be stored with the provenance data 116 in the database 110 by the database server 108. In other cases, the application server 106 supports the execution of at least one application 118, which can process the 3D features 114 and provenance data 116 and perform one or more analysis functions or other functions involving the 3D features 114 and provenance data 116. For instance, the application server 106 may process the 3D features 114 and provenance data 116 in order to generate graphical user interfaces showing the 3D structure(s) of one or more scenes, where users may select certain 3D features 114 within the scenes and view the provenance data 116 for those 3D features 114. Note that the same device may execute the applications 112 and 118, or different devices may be used to execute the applications 112 and 118.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of information used by the application server 106, such as the 3D features 114 and associated provenance data 116. Note that the database server 108 may also be used within the application server 106 to store information, in which case the application server 106 may store the information itself.

Although FIG. 1 illustrates one example of a system 100 supporting 3D feature provenance for targeting, exploitation, or other functions, various changes may be made to FIG. 1. For example, the system 100 may include any suitable number of user devices 102a-102d, networks 104, application servers 106, database servers 108, and databases 110. Also, these components may be located in any suitable locations and might be distributed over a large area. In addition, while FIG. 1 illustrates one example operational environment in which 3D feature provenance for targeting, exploitation, or other functions may be used, this functionality may be used in any other suitable system.

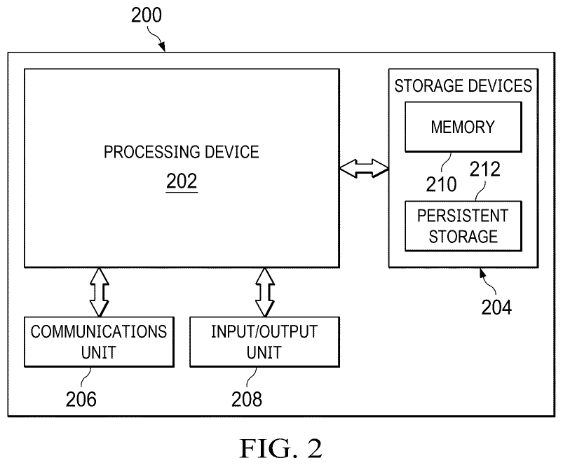

FIG. 2 illustrates an example device 200 supporting 3D feature provenance for targeting, exploitation, or other functions according to this disclosure. One or more instances of the device 200 may, for example, be used to at least partially implement the functionality of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

In some embodiments, instructions can be executed by the processing device 202 in order to implement the functionality of the one or more applications 112, 118. For example, the processing device 202 may execute instructions that cause the processing device 202 to extract or otherwise obtain 3D features 114, identify provenance data 116 associated with the 3D features 114, and store the 3D features 114 and provenance data 116 (such as in the database 110). Also or alternatively, the processing device 202 may execute instructions that cause the processing device 202 to obtain 3D features 114 and provenance data 116 (such as from the database 110) and perform one or more analysis functions or other functions involving the 3D features 114 and provenance data 116.

Although FIG. 2 illustrates one example of a device 200 supporting 3D feature provenance for targeting, exploitation, or other functions, various changes may be made to FIG. 2. For example, computing and communication devices and systems come in a wide variety of configurations, and FIG. 2 does not limit this disclosure to any particular computing or communication device or system.

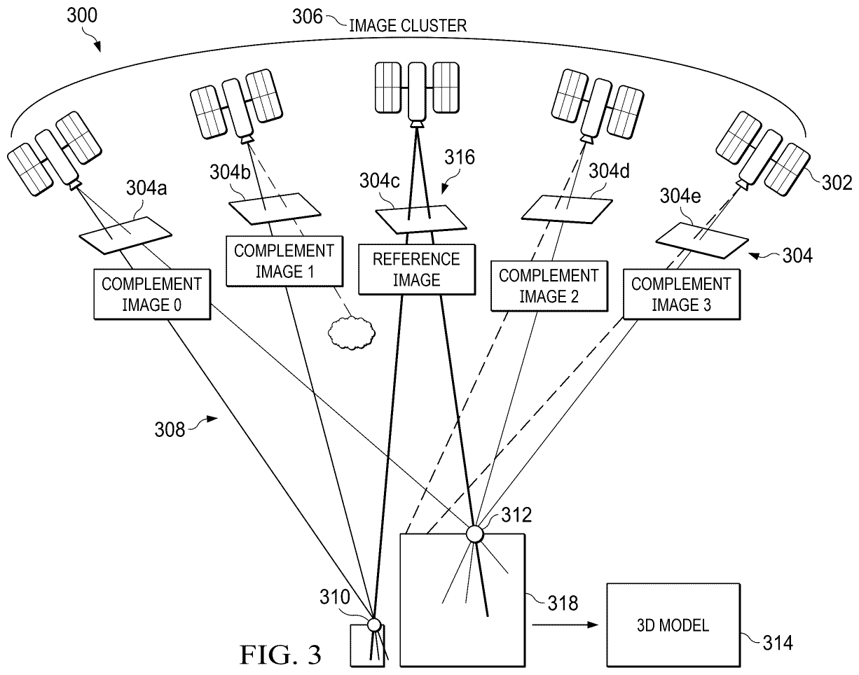

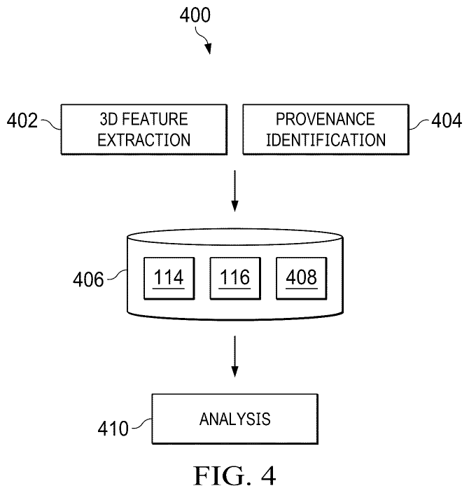

FIGS. 3 and 4 illustrate example processes 300 and 400 for extracting 3D features 114 and associated provenance data 116 according to this disclosure. For ease of explanation, the processes 300 and 400 shown in FIGS. 3 and 4 are described as being performed by the application server 106 in the system 100 shown in FIG. 1, where the application server 106 may be implemented using one or more instances of the device 200 shown in FIG. 2. However, the processes 300 and 400 shown in FIGS. 3 and 4 may be performed using any other suitable device(s) and in any other suitable system(s).

As shown in FIG. 3, the process 300 generally illustrates how 3D features 114 associated with a scene may be extracted from imagery. In this example, one or more satellites 302 may be used to capture images 304a-304e (referred to generically as images 304) of a scene over time. In some cases, the images 304 may be said to form a cluster 306. In some cases, a cluster 306 represents a set of images 304 that may be considered optimal for use in extracting 3D features, such as due to their similar collection angles, similar solar angles, similar dates of collection, and/or other advantageous conditions. Note that the images 304 within the cluster 306 may be captured by a single satellite 302 or multiple satellites 302. Different viewing geometries (positions and orientations of satellites 302) mean that features within the images 304 can be associated with different ray paths 308, and thus the 3D coordinates of features in a scene can be extracted from different viewpoints.

The images 304 here can be processed to extract various 3D features associated with the scene. In this example, the 3D features take the form of 3D points 310-312 stored in a 3D model 314. The 3D features may be extracted using any suitable image processing technique or techniques. In some cases, for instance, the 3D features can be extracted using reference image-based multi-image geopositioning (MIG). The reference image-based MIG approach identifies a reference image (in this case the image 316 in FIG. 3), and each 3D feature is extracted based on a feature captured in the reference image 316 and in one or more other images 304. As a particular example, “N-ray” intersections from various subsets of images 304 in the set of images can be used to extract the 3D points 310-312 or other 3D features. The other (non-reference) images 304 used here may be referred to as complement images 304.

Among other things, the capture time of the reference image 316 can be used to reflect temporal content of 3D scene content derived from other images 304. For instance, when the reference image 316 is captured at a specified time, all 3D features associated with the scene can be extracted relative to the reference image 316, so it is known that all extracted 3D features are current at least as of the date and time of the reference image 316. Note that this does not necessarily require the reference image 316 to be the oldest image. Rather, the reference image 316 may be selected in any suitable manner and may represent the most recent image 304 of the scene in some cases.

Not all complement images 304 may need to be included in or used during the extraction of the 3D features. In this example, for instance, a complement image 304b contains cloud cover (or other object(s) obscuring at least a portion of the scene). As a result, the image 304b may be excluded partially or entirely from use in extracting 3D features 310-312 associated with the scene. Having said that, if at least part of the scene is still visible in an image 304 despite the object(s), the image 304 could still potentially be used to extract 3D features associated with the visible portion(s) of the scene within that image 304, as shown with respect to the extracted feature 310. One or more features (such as the feature 310) may also or alternatively be obscured from other complement images (such as images 304d and 304e) due to viewing geometries. In this case, for example, the feature 310 may be obscured in the images 304d and 304e by a tall building 318 or other structure.

In this example, 3D points 310-312 or other 3D features may be extracted and used to construct a 3D model 314 of the scene. The 3D model 314 may represent any suitable type of model, such as at least one 3D point cloud, digital surface model (DSM), or polygonal mesh. The 3D model 314 may be used in various ways, such as by using the 3D model 314 to render images of the modeled scene from one or more viewpoints. Depending on the circumstances, there may be numerous 3D points 310-312 or other 3D features used to construct the 3D model 314. In some cases, millions of 3D points 310-312 or other 3D features may be extracted and used to construct the 3D model 314.

As can be appreciated here, the images 304 may be captured by the satellite(s) 302 over any suitable time period. In some cases, the time period may represent an extended period of time, such as one or multiple years. As a result, positions of objects within the imaged scene can change, additional objects may appear, and existing objects may no longer exist within the scene. Users or applications that utilize a 3D point cloud or other 3D model 314 may need or want to identify source imagery dates to understand how current a particular 3D point 310-312 or another 3D feature is within the 3D model 314. This may be true even when the images 304 are captured by the satellite(s) 302 over a shorter time period.

As shown in FIG. 4, the process 400 can be used to support the identification and use of provenance data 116, which in some cases can occur in an end-to-end manner. In this example, the process 400 can include a 3D feature extraction function 402 and a provenance identification function 404. The 3D feature extraction function 402 generally operates to process image data (and optionally additional data) in order to extract 3D points 310-312 or other 3D features 114 associated with one or more scenes. As described above, this can be done in various ways, such as by using the reference image-based MIG approach. In some cases, the 3D feature extraction function 402 may be performed by an application 112 executed by the application server 106.

The provenance identification function 404 generally operates to identify the sources used to extract each of the 3D features 114. For example, each 3D point 310-312 or other 3D feature 114 can be extracted using multiple images 304. For each 3D point 310-312 or other 3D feature 114, the provenance identification function 404 can identify (i) which cluster 306 of images 304 was used to extract that 3D point 310-312 or other 3D feature 114 and (ii) which images 304 in that cluster 306 were used to extract that 3D point 310-312 or other 3D feature 114. The provenance identification function 404 can thereby generate provenance data 116 for each 3D point 310-312 or other 3D feature 114.

The extracted 3D points 310-312 or other 3D features 114 and the identified provenance data 116 can be stored in a library 406, which in some cases may represent or be stored in the database 110. The 3D features 114 and the provenance data 116 can be stored in the library 406 using relational database tables or stored in the library 406 in any other suitable manner. There can also be additional data 408 that identifies which images 304 are captured by which satellites 302 or other devices. For instance, the additional data 408 may take the form of a “sidecar” file or other file that stores metadata or other data related to the images 304. As a particular example, a 3D point cloud may be stored using a binary point file (BPF) format, and the additional data 408 could be included in a BPF file. Of course, any other suitable file formats may be supported here, such as the GeoTIFF (tag image file format) or LAS format. By combining the provenance data 116 for each specific 3D feature 114 and at least some of the additional data 408, it is possible to identify the specific reference image 316 and the specific complement image(s) 304 used to extract that specific 3D feature 114.

In some embodiments, each image 304 may have an associated timestamp, such as in the file name of the image 304 itself. As a result, at least one timestamp can be associated with each specific 3D feature 114. For example, as noted above, each 3D feature 114 can be extracted using a reference image 316 and one or more complement images 304, and the timestamp associated with the reference image 316 may be used as a known valid time for that 3D feature 114. Even if one or more complement images 304 was captured prior to the reference image 316, the extraction of the 3D feature 114 using the reference image 316 can guarantee that the 3D feature 114 was associated with the scene as of the date and time of the reference image 316. If one, some, or all of the images 304 lack timestamps, the timestamps of the images 304 could be included in the additional data 408. Thus, a timestamp could be associated with a reference image 316 used to extract a 3D feature 114, again allowing a known valid time for that 3D feature 114 to be identified.

The 3D features 114, provenance data 116, and additional data 408 may be used in any suitable manner. In this example, this information is made available to one or more analysis applications 410. In some cases, the one or more analysis applications 410 may represent one or more applications 118 executed by the application server 106. Each analysis application 410 may obtain at least some of the information in the library 406 and process this information to perform one or more functions. The specific function(s) performed by the analysis application(s) 410 can vary widely based on the specific use case. For instance, the analysis application(s) 410 may be used to support targeting, automated UAV navigation, or other civilian-related or defense-related functions. In this way, the process 400 supports an end-to-end approach for tracking provenance in each stage of the process 400 from generation to storage to exploitation. This enables a number of subsequent functions to occur based on the provenance of each 3D feature 114.

Note that while it is often assumed above that the time of each 3D feature 114 can be verified, it is possible to verify other aspects of each 3D feature 114. For example, there may be a requirement that a certain action or actions may only occur if one or more 3D features 114 have temporal relevance (meaning those 3D features 114 were extracted using images 304 captured within a certain time period like a recent time period), only approved satellites 302 or other devices were used to capture the images 304 used to extract those 3D features 114, and/or a specific minimum number of images 304 were used to extract those 3D features 114.

Although FIGS. 3 and 4 illustrate one example of processes 300 and 400 for extracting 3D features 114 and associated provenance data 116, various changes may be made to FIGS. 3 and 4. For example, the process 300 may involve the use of any other or additional imaging sensors or other sensors instead of or in addition to the satellites 302. Also, each cluster 306 may include any suitable number of images 304.

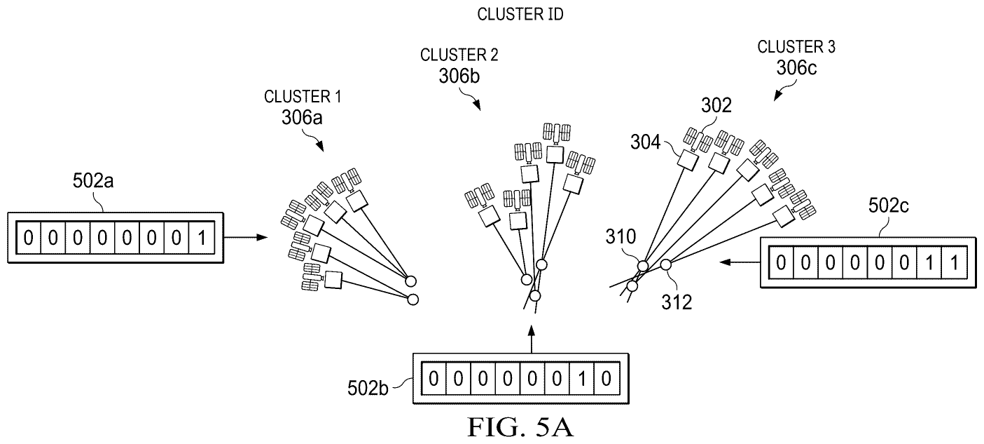

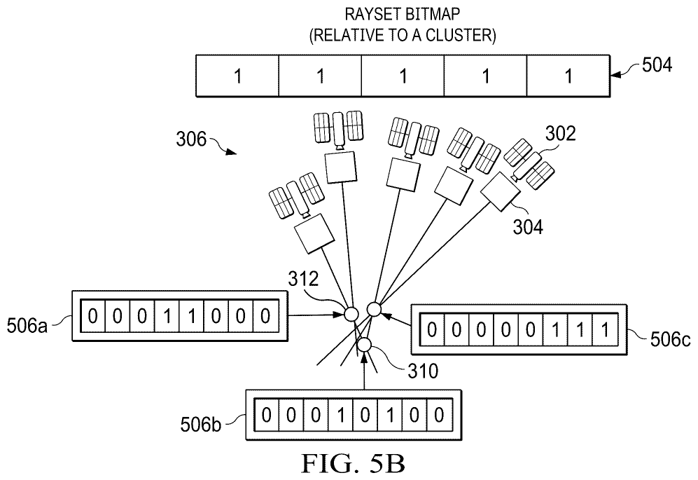

FIGS. 5A and 5B illustrate an example format for provenance data 116 according to this disclosure. For ease of explanation, the format for the provenance data 116 shown in FIGS. 5A and 5B is described as being used by the application server 106 in the system 100 shown in FIG. 1, where the application server 106 may be implemented using one or more instances of the device 200 shown in FIG. 2. However, the format for the provenance data 116 shown in FIGS. 5A and 5B may be used by any other suitable device(s) and in any other suitable system(s).

As shown in FIG. 5A, there can be multiple clusters 306a-306c of images 304 of scenes captured by one or more satellites 302 or other devices. In this example, there are three clusters 306a-306c shown, but any suitable number of clusters may be supported. Each cluster 306a-306c here is associated with a cluster identifier 502a-502c, and each cluster identifier 502a-502c uniquely identifies one of the clusters 306a-306c. In this example, each cluster identifier 502a-502c represents an eight-bit value, so the cluster identifiers 502a-502c can be used to uniquely identify up to 256 different clusters. Note, however, that the cluster identifiers 502a-502c can have any other suitable lengths as needed or desired.

As shown in FIG. 5B, within each cluster 306a-306c, a rayset bitmap 504 can be defined, where the rayset bitmap 504 includes one bit for each image 304 within a cluster 306. In some cases, each cluster 306 may include up to eight images 304, so the corresponding rayset bitmap 504 may be one byte (eight bits) in length. When an image 304 is used as a reference image 316 or a complement image 304 when extracting a 3D feature 114, the bit associated with that image 304 may be set to one value (such as a “1”). Otherwise, when an image 304 does not represent the reference image 316 and the complement image(s) 304 used to extract a 3D feature 114, the bit associated with that image 304 may be set to another value (such as a “0”).

This approach can be used to generate a rayset identifier 506a-506c for each 3D feature 114, where each rayset identifier 506a-506c identifies the specific image 304 used to extract that 3D feature 114. In this specific example, for instance, the rayset identifier 506a indicates that a first 3D feature 114 was extracted using the fourth and fifth images 304 in the cluster 306. The rayset identifier 506b indicates that a second 3D feature 114 was extracted using the third and fifth images 304 in the cluster 306. The rayset identifier 506c indicates that a third 3D feature 114 was extracted using the first, second, and third images 304 in the cluster 306. Because a 3D feature 114 would not be extracted using zero images, each rayset identifier 506a-506c may be used to identify one of 255 different possible combinations of images 304. Note, however, that the rayset identifiers 506a-506c can have any other suitable lengths as needed or desired.

In the illustrated approach, each 3D feature 114 can be associated with two bytes of provenance data 116, one byte containing a cluster identifier 502a-502c and one byte containing a rayset identifier 506a-506c. As a result, using the illustrated approach, each 3D feature 114 can have its associated provenance identified and tracked using two bytes of provenance data 116 (prior to compression of the provenance data 116). As noted above, this can be beneficial, particularly when numerous 3D features 114 may be extracted for each of one or more scenes.

Although FIGS. 5A and 5B illustrate one example of a format for provenance data 116, various changes may be made to FIGS. 5A and 5B. For example, provenance data 116 may have any other suitable format, including those with cluster identifiers and rayset identifiers of other lengths. Also, there is no requirement that cluster identifiers and rayset identifiers have the same length.

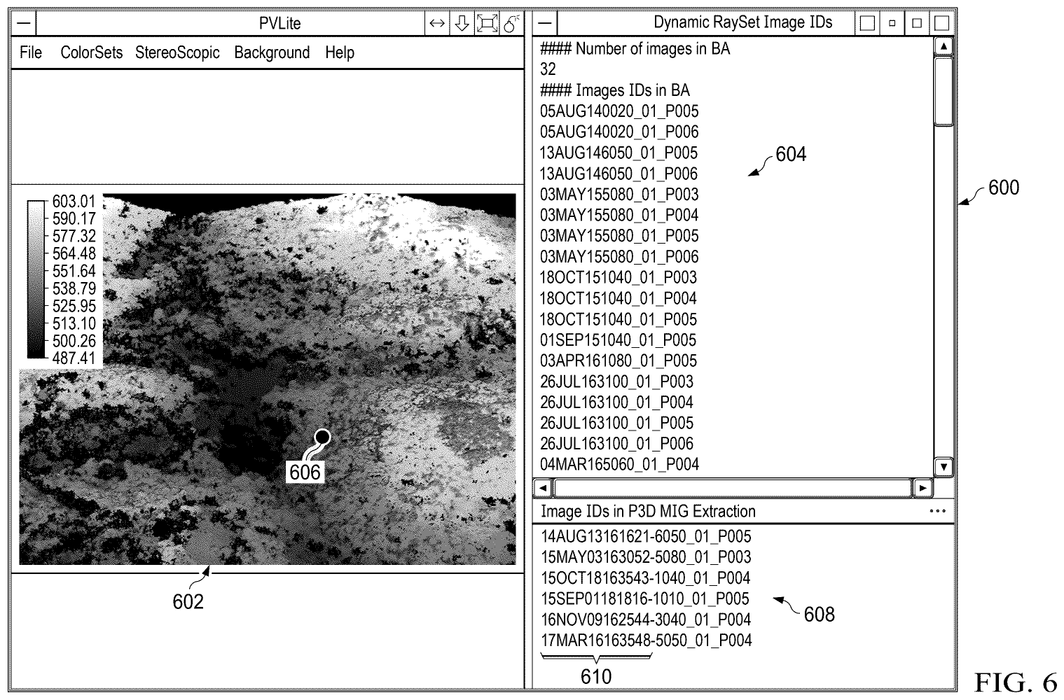

FIG. 6 illustrates an example graphical user interface 600 containing content based on provenance data 116 according to this disclosure. For ease of explanation, the graphical user interface 600 shown in FIG. 6 is described as being generated by the application server 106 in the system 100 shown in FIG. 1, where the application server 106 may be implemented using one or more instances of the device 200 shown in FIG. 2. However, the graphical user interface 600 shown in FIG. 6 may be generated using any other suitable device(s) and in any other suitable system(s).

As shown in FIG. 6, the graphical user interface 600 presents a visualization 602 of a 3D model for viewing by one or more users. The visualization 602 can be associated with any suitable environment and cover any suitable geographic area. The visualization 602 can also present information in any suitable form, such as in topographic form. In general, this disclosure is not limited to any specific type of imagery associated with scenes being imaged. Although not shown here, the one or more users may be allowed to zoom in, zoom out, scroll in different directions, or otherwise navigate within the visualization 602.

The graphical user interface 600 in this example also includes a total listing 604 of image identifiers. The listing 604 of image identifiers identifies the total set of images across all clusters 306 used in the extraction of all 3D features 114. In this example, the listing 604 of image identifiers refers to a total of thirty-two images used in different combinations of various clusters.

The graphical user interface 600 in this example also allows the one or more users to select specific points 606 within the visualization 602. Each point 606 can be associated with a 3D feature 114 presented within the visualization 602 being viewed. For each selected point 606, the graphical user interface 600 can include a listing 608 of the image identifiers used to extract the 3D feature 114 at that specific point 606. In some cases, the reference image 316 used to extract the 3D feature 114 at that specific point 606 may be differentiated, such as by identifying the reference image 316 using one color (like red) and identifying one or more complement images 304 using another color (like blue).

In this particular example, each image identifier in the listings 604 and 608 includes a timestamp 610. The timestamp 610 includes a date in the form day-month-year, along with a time in the form hour-minutes-seconds. Thus, for example, the first image identifier in the listing 608 represents an image 304 captured on Aug. 14, 2013 at 16:16:21 (which can be expressed as 4:16:21 pm). Using this type of approach, the one or more users may quickly determine that the 3D feature 114 at the specific point 606 is known to have existed as of the time of the reference image 316 used to extract that 3D feature 114.

As a user navigates the 3D model from point 606 to point 606, the image identifiers used in the extraction (identified in the listing 608) can dynamically change from point 606 to point 606. This is based on the stored provenance data, such as the cluster identifier 502a-502c and rayset identifier 506a-506c associated with each user-selected point 606.

Although FIG. 6 illustrates one example of a graphical user interface 600 containing content based on provenance data 116, various changes may be made to FIG. 6. For example, the layout, content, and arrangement of information in the graphical user interface 600 can vary widely based on the implementation, and FIG. 6 does not limit the scope of this disclosure to any particular interface. Also, provenance data associated with 3D features 114 may be used in any other suitable manner.

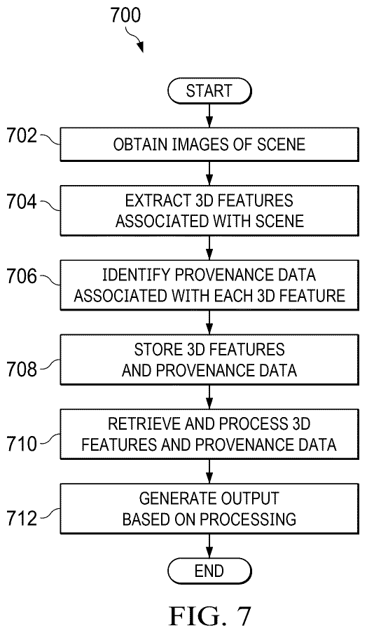

FIG. 7 illustrates an example method 700 for identifying and using 3D feature provenance for targeting, exploitation, or other functions according to this disclosure. For ease of explanation, the method 700 shown in FIG. 7 is described as being performed by the application server 106 in the system 100 shown in FIG. 1, where the application server 106 may be implemented using one or more instances of the device 200 shown in FIG. 2 and perform the processes 300 and 400 shown in FIGS. 3 and 4. However, the method 700 shown in FIG. 7 may be performed using any other suitable device(s) and with any other suitable process(es) and in any other suitable system(s).

As shown in FIG. 7, images of at least one scene are obtained at step 702. This may include, for example, the processing device 202 of the application server 106 obtaining images 304 captured by one or more satellites 302 or other devices, where the images 304 may be included in a cluster 306 of images. Note that the images 304 here may represent images captured over any suitable time period. In some cases, the images may be captured over a prolonged period of time, such as one or more years. However, this may not necessarily be the case.

Various 3D features associated with the at least one scene are extracted at step 704. This may include, for example, the processing device 202 of the application server 106 processing sets of images 304 in order to extract 3D points 310-312 or other 3D features 114 associated with each scene. Any suitable techniques may be used here, such as the reference image-based MIG approach. Thus, for instance, the processing device 202 of the application server 106 may identify a reference image 316 for a specific scene, identify complement images 304 for that specific scene, and extract each 3D feature 114 based on a feature captured in the reference image 316 and in one or more complement images 304.

Provenance data associated with each 3D feature is identified at step 706. This may include, for example, the processing device 202 of the application server 106 identifying, for each 3D feature 114, (i) the cluster 306 of images 304 used to extract the 3D feature 114 and (ii) the images 304 in the cluster 306 that were used to extract the 3D feature 114. As a particular example, the processing device 202 of the application server 106 may identify a cluster identifier 502a-502c and a rayset identifier 506a-506c for each 3D feature 114.

The 3D features and provenance data are stored at step 708. This may include, for example, the processing device 202 of the application server 106 storing the 3D points 310-312 or other 3D features 114 and the provenance data 116 in a library 406 or other suitable storage location(s). The 3D features 114 and provenance data 116 may be used in any suitable manner. For instance, the 3D features and provenance data may be retrieved and processed at step 710, and at least one output can be generated and provided at step 712. The specific use of the 3D features 114 and provenance data 116 can vary depending on the implementation. For instance, the 3D features 114 could be retrieved and used to generate a visualization 602 in a graphical user interface 600, and the provenance data 116 can be used to identify specific images from which one or more 3D features 114 were extracted.

Although FIG. 7 illustrates one example of a method 700 for identifying and using 3D feature provenance for targeting, exploitation, or other functions, various changes may be made to FIG. 7. For example, while shown as a series of steps, various steps in FIG. 7 can overlap, occur in parallel, occur in a different order, or occur any number of times. As a particular example, 3D features 114 may be extracted and associated provenance data 116 may be identified over an extended period of time, such as when steps 702-708 occur repeatedly over time. The stored 3D features 114 and associated provenance data 116 may be used at any suitable points, meaning steps 710-712 may occur at one or more times. It is therefore possible, for instance, to extract and store 3D features 114 and associated provenance data 116, have that information retrieved and used, extract/identify and store additional 3D features 114 and associated provenance data 116, and again have that information retrieved and used. Also, there is no requirement that a single application or device perform all steps of the method 700. Thus, for example, one or more devices may perform steps 702-708, and one or more other devices may perform steps 710-712.

Note that while the reference image-based MIG approach is described above as being used to extract 3D features, any other suitable technique may be used to extract the 3D features. For example, multi-view stereo (MVS) is another approach that can be used to perform 3D reconstruction and extract 3D features. In general, this disclosure is not limited to the use of any specific technique for extracting 3D features.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining three-dimensional (3D) features associated with a scene, each 3D feature extracted based on two or more of multiple images of the scene;
identifying provenance data associated with each of the 3D features, the provenance data for each 3D feature identifying one or more sources of the two or more images used to extract the 3D feature; and
storing the 3D features and the provenance data associated with the 3D features.

2. The method of claim 1, wherein the provenance data associated with each of the 3D features comprises:
a first identifier identifying a cluster of images used to extract the 3D feature; and
a second identifier identifying, within the cluster of images, which of the images were used to extract the 3D feature.

3. The method of claim 2, wherein:
the first identifier is one byte in length; and
the second identifier is one byte in length.

4. The method of claim 1, wherein:
each of the images is associated with a timestamp; and
at least one of the 3D features is extracted using two or more images captured at different times.

5. The method of claim 1, further comprising:
processing at least some of the 3D features and the provenance data to generate a visualization of the scene;
generating a graphical user interface comprising the visualization;
receiving a user selection of a point within the visualization; and
updating the graphical user interface to display an identification of the two or more images used to extract a 3D feature at the point within the visualization.

6. The method of claim 1, further comprising:
extracting each 3D feature by:
selecting a reference image from among the multiple images;
selecting one or more complement images from among the multiple images; and
extracting each 3D feature based on a presence of the 3D feature in the reference image and in at least one of the one or more complement images.

7. The method of claim 1, further comprising:
forming a 3D model of the scene based on the 3D features.

8. An apparatus comprising:
at least one processing device configured to:
obtain three-dimensional (3D) features associated with a scene, each 3D feature extracted based on two or more of multiple images of the scene;
identify provenance data associated with each of the 3D features, the provenance data for each 3D feature identifying one or more sources of the two or more images used to extract the 3D feature; and
store the 3D features and the provenance data associated with the 3D features.

9. The apparatus of claim 8, wherein the provenance data associated with each of the 3D features comprises:
a first identifier identifying a cluster of images used to extract the 3D feature; and
a second identifier identifying, within the cluster of images, which of the images were used to extract the 3D feature.

10. The apparatus of claim 9, wherein:
the first identifier is one byte in length; and
the second identifier is one byte in length.

11. The apparatus of claim 8, wherein:
each of the images is associated with a timestamp; and
the at least one processing device is configured to extract at least one of the 3D features using two or more images captured at different times.

12. The apparatus of claim 8, wherein the at least one processing device is further configured to:
process at least some of the 3D features and the provenance data to generate a visualization of the scene;
generate a graphical user interface comprising the visualization;
receive a user selection of a point within the visualization; and
update the graphical user interface to display an identification of the two or more images used to extract a 3D feature at the point within the visualization.

13. The apparatus of claim 8, wherein:
the at least one processing device is further configured to extract each 3D feature; and
to extract each 3D feature, the at least one processing device is configured to:
select a reference image from among the multiple images;
select one or more complement images from among the multiple images; and
extract each 3D feature based on a presence of the 3D feature in the reference image and in at least one of the one or more complement images.

14. The apparatus of claim 8, wherein the at least one processing device is further configured to form a 3D model of the scene based on the 3D features.

15. A non-transitory machine readable medium containing instructions that when executed cause at least one processor to:
obtain three-dimensional (3D) features associated with a scene, each 3D feature extracted based on two or more of multiple images of the scene;
identify provenance data associated with each of the 3D features, the provenance data for each 3D feature identifying one or more sources of the two or more images used to extract the 3D feature; and
store the 3D features and the provenance data associated with the 3D features.

16. The non-transitory machine readable medium of claim 15, wherein the provenance data associated with each of the 3D features comprises:
a first identifier identifying a cluster of images used to extract the 3D feature; and
a second identifier identifying, within the cluster of images, which of the images were used to extract the 3D feature.

17. The non-transitory machine readable medium of claim 16, wherein:
the first identifier is one byte in length; and
the second identifier is one byte in length.

18. The non-transitory machine readable medium of claim 15, wherein:
each of the images is associated with a timestamp; and
the instructions when executed cause the at least one processor to extract at least one of the 3D features using two or more images captured at different times.

19. The non-transitory machine readable medium of claim 15, further containing instructions that when executed cause the at least one processor to:
process at least some of the 3D features and the provenance data to generate a visualization of the scene;
generate a graphical user interface comprising the visualization;
receive a user selection of a point within the visualization; and
update the graphical user interface to display an identification of the two or more images used to extract a 3D feature at the point within the visualization.

20. The non-transitory machine readable medium of claim 15, further containing instructions that when executed cause the at least one processor to extract each 3D feature, wherein the instructions that when executed cause the at least one processor to extract each 3D feature comprise instructions that when executed cause the at least one processor to:
select a reference image from among the multiple images;
select one or more complement images from among the multiple images; and
extract each 3D feature based on a presence of the 3D feature in the reference image and in at least one of the one or more complement images.
